(19) United States
(12) Patent Application Publication
(10) Pub. No.: US 2012/0216686 A1
(43) Pub. Date: Aug. 30, 2012

(54) Side flame stove top grill

(76) Inventor: Daniel L. Panea, Peoria, IL (US)

(21) Appl. No.: 12/932,450

(22) Filed: Feb. 25, 2011

(51) Int. Cl. A47J 37/07

(52) U.S. Cl. 99/450

(57) ABSTRACT

A side flame stove top grill apparatus that has a base member with the shape of a pan, and a lid with a handle. The lid extends outside of the pan to cover a burner. A wire grid that supports the food rests between the pan, which holds a body of water, and the lid.

### REFERENCE CITED

U.S. PATENT DOCUMENTS

| | | |
|---|---|---|
| 3,301,172 | January 1967 Haro | 99/446 |
| 4,454,805 | June 1974 Matthews | 99/400 |
| 4,694 816 | September 1987 Fabbro | 126/41 R |
| 4,729 297 | March 1988 Iranzadi | 99/401 |
| 4,976,252 | December 1990 Cianciola | 126/27 |

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to a cooking grill, and more particularly to grills that are positioned on the surface of the gas or electric stove, or in a combination with an independent gas or electric burner to grill foods in a confined smokeless configuration.

2. Description of the Prior Art

There is a desirability of many families to grill meats and food in their kitchen due to harsh weather conditions, or limited outdoor space, which minimizes the use of outdoor barbeques. The advantage of using a grill over a pan is that food is able to eliminate the fat during the cooking process. The Prior Art devices of this type are based on a variety of different design configuration, all of which have the same circular structure, with the gas or electric burner in the center of the grill. Examples of these designs can be found in U.S. Pat. No. 3,301,172, 4,454,805, 4,694,816, and 4,976,252.

The present invention is designed to work with the gas or electric burner on the side of the grill. This design eliminates the need of a separate trey or plate that collects the fat drippings and juices, as the base of the grill is not located on top of the burner. The base of the grill, which in fact is a pan, acts as a plate collector itself. It is in the form of a rectangular or square pan containing water, which collects all the drippings and juices, and keep the food moist. Compared to previous Prior Art, present invention is designed to provide the best quality of food in the most efficient and economical way. None of these patents suggest the novel design of the present invention.

### BRIEF SUMMARY OF THE INVENTION

The present invention is a grill device to be position on the side of one or two independent burners or a stove top. The grill is made of three parts: lid, grill, and base member. It is designed such way that the cover extends outside the grilling area to cover the burner. The grill is positioned directly on top of the drip pan, which is away from the flame of the burner. The extended cover assures that the hot air waves from the burner move over the grill area. The present invention has the base and the food away from the flame, such that base member does not become very hot during cooking, fact that makes the grill innovative. All three parts can be removed very easily for convenient cleaning. When the unit is designed for two or more burners, the size of the cover is increased to extend over each of these burners.

Therefore, it is the main object of the present invention to provide a device for grilling food over one or more electric or gas side burners.

It is still another object of the present invention to provide a side flame stove top grill made of only 3 parts which is very easy to manufacture, use, and clean.

It is yet another object of the present invention to provide a side flame stove top grill which reduces excessive smoking and odor during cooking.

These and further objects and advantages of the invention will become apparent to those skilled in the aft after considering the following detailed specification and the accompanying drawings, wherein:

### BRIEF DESCRIPTION OF THE SEVERAL VIEWS OF THE DRAWING

FIG. 1 is an exploded perspective view of the cooking device of the invention;

FIG. 2 is a top view of the cover member;

FIG. 3 is a top view of the grill member;

FIG. 4 is a top view of the base member;

FIG. 5 illustrates a cross-sectional view of the apparatus along line A-A of FIG. 2;

FIG. 6 is an exploded perspective view of the cooking device with two burners;

FIG. 7 illustrates a cross-sectional view along side of the cooking devices with two burners.

### DETAILED DESCRIPTION OF THE INVENTION

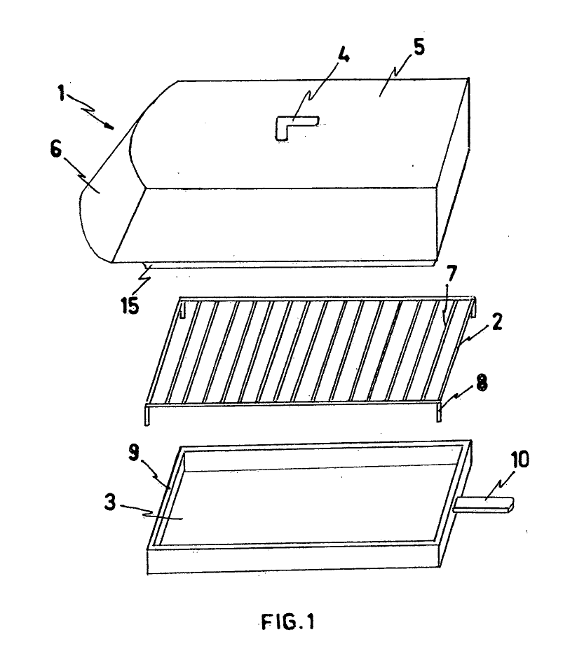

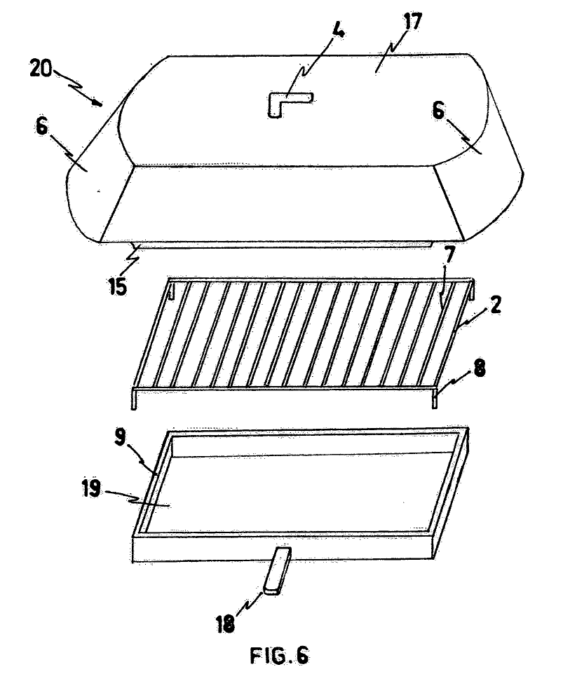

Referring to FIG. 1, there is shown a cooking device 1 having a base 3, a wire grid 2, and a lid 5. Base 3 is substantially a square or rectangle pan where a shallow body of water 11 may be deposited as showing in FIG. 5. During cooking, the base 3 is placed on the side of burner 14. The base 3 also has a side wall 9. On one of the smallest sides of the base, the side wall 9 has a handle 10 mounted on it. The wire grid 2 has the same shape as the pan with a size that is slightly smaller than base 3 so that the wire grid 2 may rest inside the base 3. The wire grid 2 is made of a wire frame and several soldered parallel wires 7. The wire grid 2 also has 4 legs 8 that fit inside the pan. The lid 5 has 3 lateral walls 16, and has an extended wall in conical shape 6 at one of the sides to cover the burner 14. The lid 5 also has an inside flange 15 that fits between the walls 9 of the pan. The lid 5 also has a handle 4 to facilitate removal of the lid during cooking. Grill type cooking is accomplished as hot wave rises up on the side of the pan, hits the conic section of the lid 5 and is deflected over the wire grid 2 where the food 12 is located.

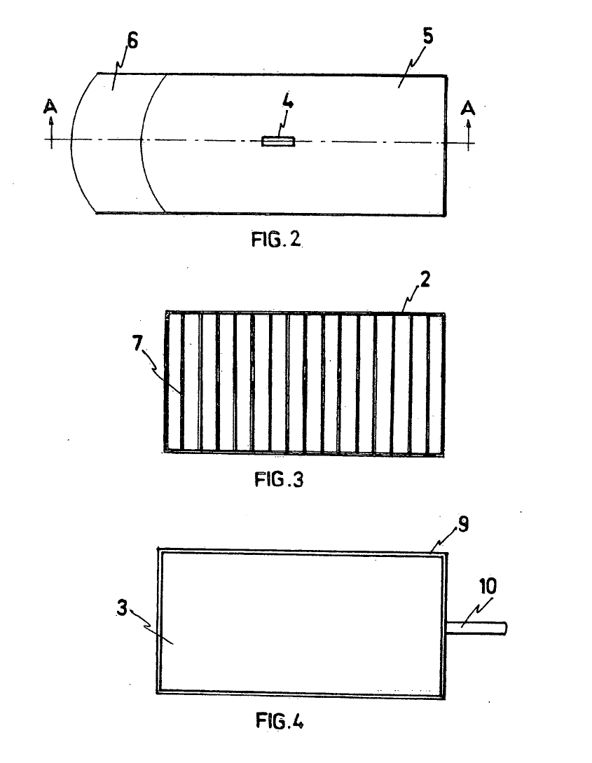

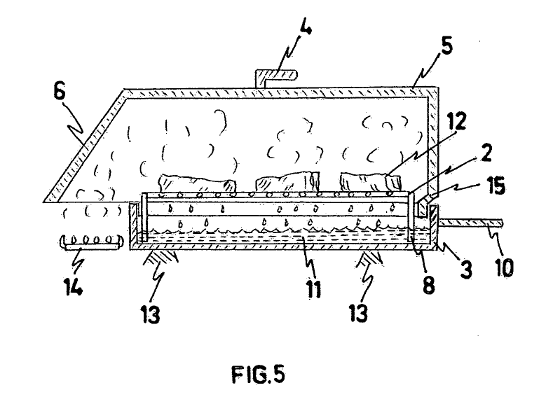

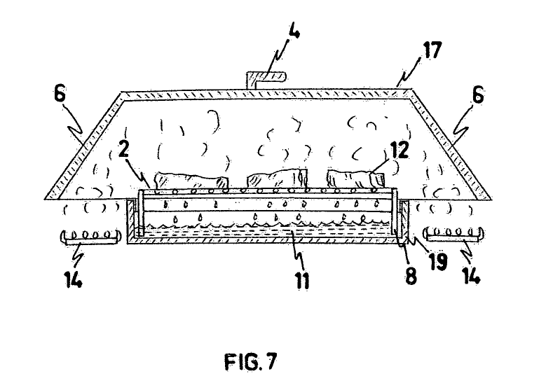

As can be seen with reference to FIGS. 6 and 7, the cooking device 20 has essentially the same features as the one-burner cooking device shown in FIGS. 1 through 5. The embodiment 20 is made of three pieces: a base 19, a wire grid 2, and a lid 17. The lid 17 has an additional conical extension 6 on the opposite side of the lid to cover the second burner. The base 19 has attached a handle 18 on one of the sides between burners.

Many modifications of the present invention are possible in light of the above teaching. The wire grid, for example, could be supported by the side of the base, instead by the legs within the base, and might be raised or lowered inside the cooking device. The shapes and dimensions of the various parts can be modified, without departing from the spirit and scope of the invention. It is believed that the foregoing description conveys the best understanding of the objects and advantages of the present invention. Different embodiments may be made of the inventive concept of this invention. It is to be understood that all matter disclosed herein is to be interpreted merely as illustrative, and not in a limiting sense, except as set forth in the following appended claims.

What is claimed is:

1. A device for cooking food with electric or gas burners, comprising:
A. A base member having substantially the shape of a pan;
B. A wire grid with 4 legs used for supporting food resting on the said base member and said wire grill being of slightly smaller dimensions than the said base member; and
C. A removable lid comprising a top wall, three lateral walls and a conic extension wall over the burner, and said lid being capable of resting on said base.

2. A cooking device as claimed in claim 1, further wherein said lid includes an inner flange to provide mechanical integrity to said base member.

3. A cooking device set forth in claim 1, wherein said lid includes a handle.

4. A cooking device as set forth in claim 1, wherein said base member includes a handle.

5. A cooking device as set forth in claim 1, wherein said base member, wire grid and lid member have a substantially rectangle shape.

6. A cooking device as set forth in claim 1 wherein the grease that drips off said food when cooked falls on said water in the base member.
